(19) United States
(12) Patent Application Publication
(10) Pub. No.: US 2013/0142461 A1
(43) Pub. Date: Jun. 6, 2013

(54) SPINDLE MOTOR

(71) Applicant: Chang Jo YU, Suwon (KR)

(72) Inventor: Chang Jo YU, Suwon (KR)

(73) Assignee: SAMSUNG ELECTRO-MECHANICS CO., LTD., Suwon (KR)

(21) Appl. No.: 13/398,304

(22) Filed: Feb. 16, 2012

(30) Foreign Application Priority Data
Dec. 5, 2011 (KR) 10-2011-0129019

(51) Int. Cl. F16C 32/06

(52) U.S. Cl. 384/112; 384/114

(57) ABSTRACT

There is provided a spindle motor including: a shaft; a sleeve rotatably supporting the shaft and forming a bearing clearance therewith filled with a lubricating fluid; a cover member installed on a lower end portion of the sleeve; a rotor hub coupled to an upper end portion of the shaft and having an extension wall part extended downwardly in an axial direction, to be disposed outwardly of the sleeve in a radial direction; and a stopper member fixedly installed on the extension wall part, and forming, together with an outer peripheral surface of the sleeve, a space having a liquid-vapor interface formed therein, the sleeve including a circulation hole formed therein to connect upper and lower portions thereof, the circulation hole being connected to a space formed by the stopper member and the outer peripheral surface of the sleeve.

### CROSS-REFERENCE TO RELATED APPLICATIONS

This application claims the priority of Korean Patent Application No. 10-2011-0129019 filed on Dec. 5, 2011, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A small spindle motor used in a hard disk drive (HDD) is generally provided with a fluid dynamic pressure bearing assembly, and a bearing clearance formed between a shaft and a sleeve of the fluid dynamic pressure bearing assembly is filled with a lubricating fluid such as oil. The oil filling the bearing clearance generates fluid dynamic pressure while being compressed, thereby rotatably supporting the shaft.

That is, the fluid dynamic pressure bearing assembly generally generates dynamic pressure through spiral shaped grooves in an axial direction and herringbone shaped grooves in a circumferential direction, thereby promoting stability in spindle motor rotational driving.

Meanwhile, in accordance with the recent increase in the capacity of the hard disk drive, a technical subject in which vibrations generated during driving of the spindle motor should be reduced has been generated. That is, in order to allow the hard disk drive to be driven without error occurring due to the vibrations generated during the driving of the spindle motor, demand for improvements in the performance of the fluid dynamic pressure bearing assembly included in the spindle motor has increased.

In addition, in order to improve the performance of the fluid dynamic pressure bearing assembly, there is a need to increase an interval (that is, a length of a bearing span) between the herringbone shaped grooves to move the rotating center upwardly, thereby promoting stability in spindle motor driving.

In addition, the spindle motor has been used in portable electronic devices, such that demands for a reduction in the power consumption thereof have increased.

The development of a structure capable of reducing power consumption while promoting stability in motor driving as described above has been urgently demanded.

### SUMMARY OF THE INVENTION

An aspect of the present invention provides a spindle motor capable of reducing negative pressure generation and excessive floating of a rotor and easily discharging air bubbles.

According to an aspect of the present invention, there is provided a spindle motor including: a shaft; a sleeve rotatably supporting the shaft and forming a bearing clearance therewith filled with a lubricating fluid; a cover member installed on a lower end portion of the sleeve; a rotor hub coupled to an upper end portion of the shaft and having an extension wall part extended downwardly in an axial direction so as to be disposed outwardly of the sleeve in a radial direction; and a stopper member fixedly installed on the extension wall part of the rotor hub, and forming, together with an outer peripheral surface of the sleeve, a space including a liquid-vapor interface formed therein, wherein the sleeve includes a circulation hole formed therein in order to connect upper and lower portions thereof to each other, the circulation hole being connected to a space formed by the stopper member and the outer peripheral surface of the sleeve.

The circulation hole may be inclined.

The sleeve may include a flange part extended so as to be disposed over the stopper member.

The sleeve may include a depression groove formed under the flange part and connected to the circulation hole.

At least one of a lower surface of the shaft and an upper surface of the cover member may be provided with a first thrust dynamic pressure groove for generating fluid thrust dynamic pressure.

At least one of a lower surface of the flange part and an upper surface of the stopper member may be provided with a second thrust dynamic pressure groove for generating fluid thrust dynamic pressure.

A first lubricating fluid circulation in which the lubricating fluid moves from a lower portion of the circulation hole toward an upper portion thereof and a second lubricating fluid circulation in which the lubricating fluid moves from the circulation hole toward a bearing clearance formed by the flange part and the stopper member may be generated at the time of rotational driving of the shaft.

The sleeve may include upper and lower radial dynamic pressure grooves formed in an inner peripheral surface thereof in order to generate fluid dynamic pressure at the time of the rotational driving of the shaft, and the lubricating fluid may move from the upper radial dynamic pressure groove toward the lower radial dynamic pressure groove.

The circulation hole may include a first lubricating fluid circulation hole for connecting upper and lower portions of the sleeve to each other and a second lubricating fluid circulation hole having one end connected to the first lubricating fluid circulation hole and the other end connected to a space formed by the stopper member and the outer peripheral surface of the sleeve.

A first lubricating fluid circulation in which the lubricating fluid moves from a lower portion of the first lubricating fluid circulation hole toward an upper portion thereof and a second lubricating fluid circulation in which the lubricating fluid moves from the second lubricating fluid circulation hole toward the bearing clearance formed by the flange part and the stopper member may be generated at the time of the rotational driving of the shaft.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is a bottom perspective view showing a shaft according to the embodiment of the present invention;

FIG. 3 is a perspective view showing a sleeve according to the embodiment of the present invention;

FIG. 4 is a cut-away perspective view showing the sleeve according to the embodiment of the present invention;

FIG. 5 is a perspective view showing a stopper member according to the embodiment of the present invention;

FIG. 6 is a view describing an operation of the spindle motor according to the embodiment of the present invention;

FIG. 7 is a schematic cross-sectional view showing a spindle motor according to another embodiment of the present invention; and

FIG. 8 is a view describing an operation of the spindle motor according another embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, a detailed description thereof will be omitted.

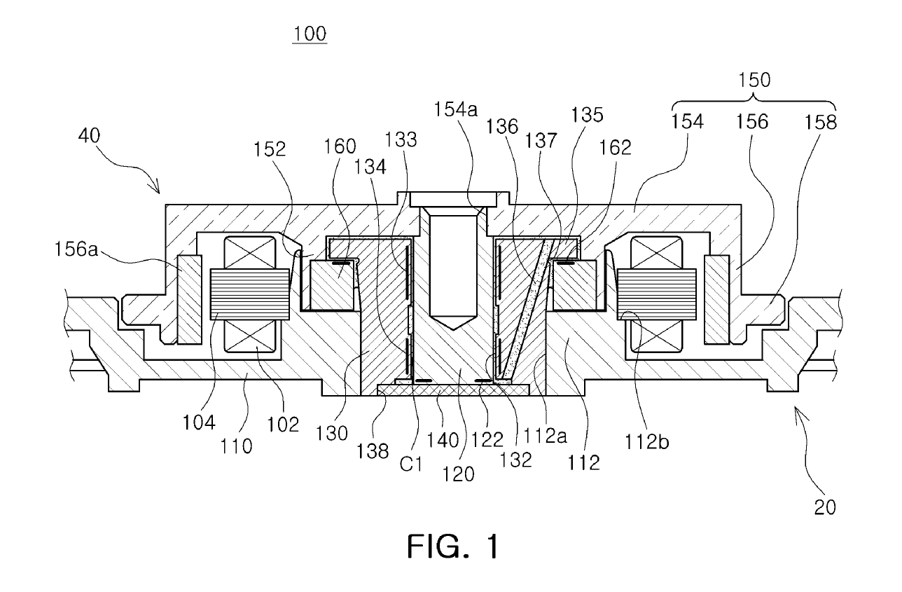

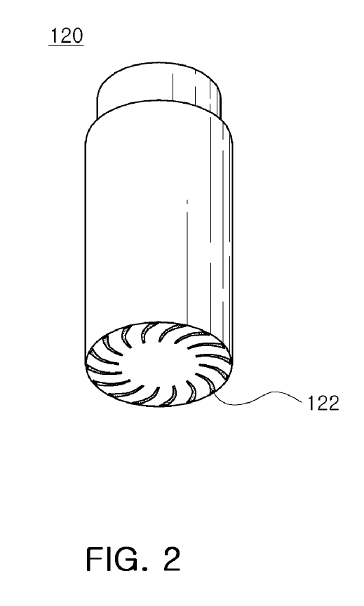

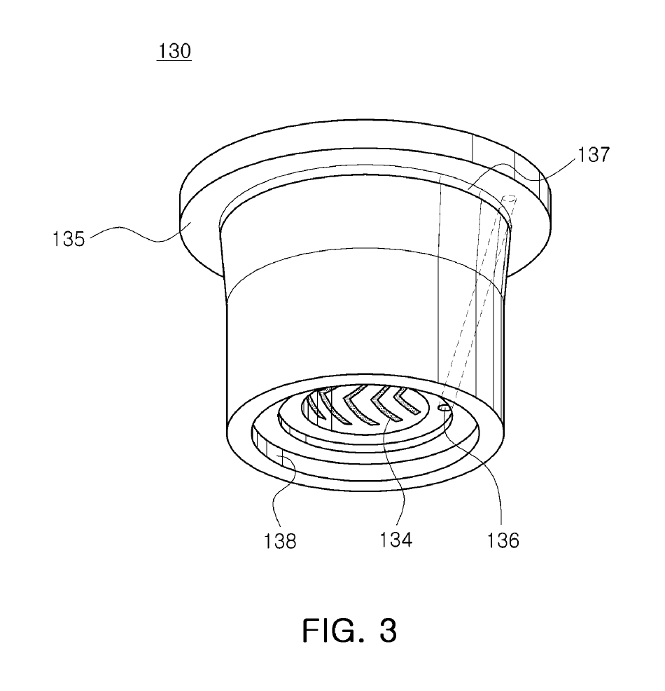

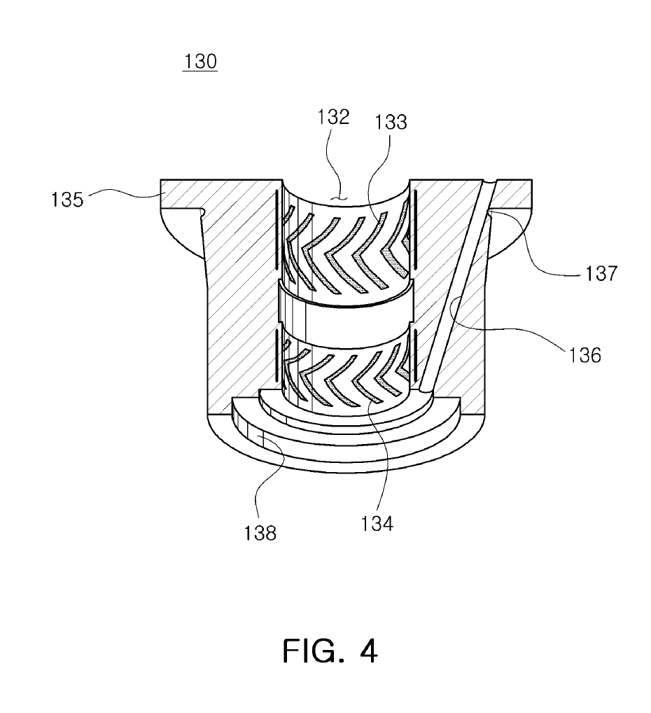

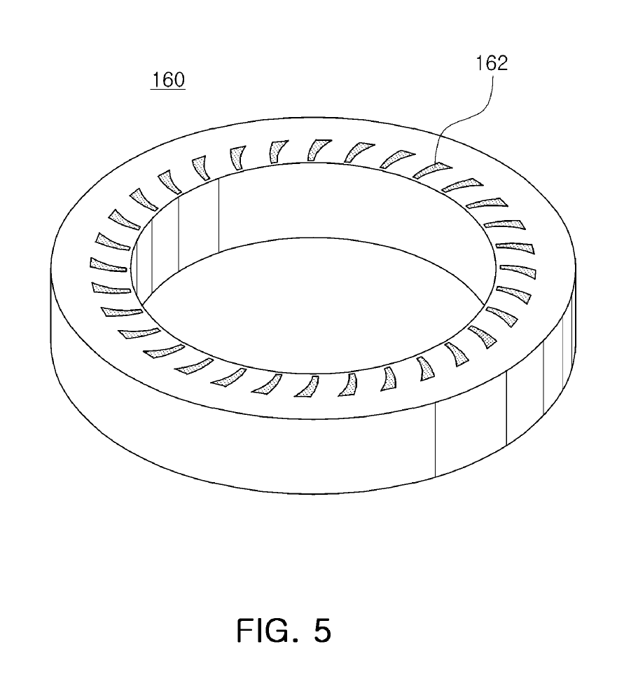

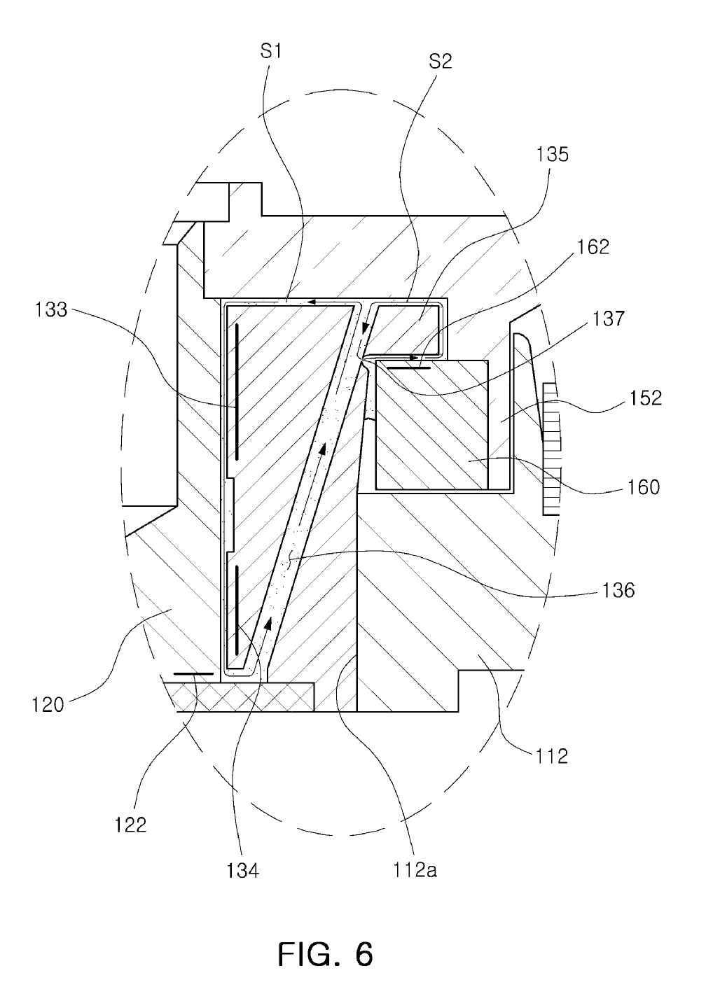

FIG. 1 is a schematic cross-sectional view showing a spindle motor according to an embodiment of the present invention; FIG. 2 is a bottom perspective view showing a shaft according to the embodiment of the present invention; FIG. 3 is a perspective view showing a sleeve according to the embodiment of the present invention; FIG. 4 is a cut-away perspective view showing the sleeve according to the embodiment of the present invention; FIG. 5 is a perspective view showing a stopper member according to the embodiment of the present invention; and FIG. 6 is a view describing an operation of the spindle motor according to the embodiment of the present invention.

Referring to FIGS. 1 through 6, the spindle motor 100 according to the embodiment of the present invention may include a base member 110, a shaft 120, a sleeve 130, a cover member 140, a rotor hub 150, and a stopper member 160 by way of example.

The spindle motor 100 may be a motor used in a recording disk driving device driving a recoding disk.

Here, terms with respect to directions will be defined. As viewed in FIG. 1, an axial direction refers to a vertical direction, that is, a direction from a lower portion of the shaft 120 toward an upper portion thereof or a direction from the upper portion of the shaft 120 toward the lower portion thereof, and a radial direction refers to a horizontal direction, that is, a direction from an outer peripheral surface of the rotor hub 150 toward the shaft 120 or from the shaft 120 toward the outer peripheral surface of the rotor hub 150.

In addition, a circumferential direction refers to a rotation direction along an outer peripheral surface of the rotor hub 150 or the shaft 120.

The base member 110, a fixed member, may configure a state 20. Here, the stator 20, that is, all fixed members except for a rotating member, may include the base member 110, the sleeve 130, and the like.

In addition, the base member 110 may include an installing part 112 having the sleeve 130 insertedly installed therein. The installation part 112 may be protruded upwardly in the axial direction and include an installation hole 112a formed therein so that the sleeve 130 may be insertedly installed therein.

In addition, the installation part 112 may include a seat surface 112b formed on an outer peripheral surface thereof so that a stator core 104 having a coil 102 wound therearound may be seated thereon. That is, the stator core 104 may be fixedly installed on the outer peripheral surface of the installation part 112 by an adhesive in a state in which it is seated on the seat surface 112b.

However, the stator core 104 may also be installed on the outer peripheral surface of the installation part 112 in a press-fitting scheme without using the adhesive. That is, a scheme of installing the stator core 104 is not limited to a scheme using the adhesive.

The shaft 120, a rotating member, may configure a rotor 40. Here, the rotor 40 indicates a member rotatably supported by the stator 20 to thereby rotate.

Meanwhile, the shaft 120 may be rotatably supported by the sleeve 130. In addition, as shown in FIG. 2, the shaft 120 may include a first thrust dynamic pressure groove 122 formed in a lower surface thereof in order to generate fluid thrust dynamic pressure at the time of rotation thereof.

Meanwhile, the first thrust dynamic pressure groove 122 is not limited to being formed in the lower surface of the shaft 120, but may also be formed in an upper surface of the cover member 140 disposed to face the lower surface of the shaft 120.

As described above, the first thrust dynamic pressure groove 122 may be formed in the lower surface of the shaft 120 or the upper surface of the cover member 140 disposed to face the lower surface of the shaft 120 to relatively reduce a length of the first thrust dynamic pressure groove 122 in a radial direction, whereby power consumption may be further reduced.

Meanwhile, the first thrust dynamic pressure groove 122 may have a herringbone shape or a spiral shape. However, the first thrust dynamic pressure groove 122 is not limited to having the above-mentioned shape, but may have any shape as long as the fluid dynamic pressure may be generated at the time of the rotation of the shaft 120.

The sleeve 130, a fixed member configuring the stator 20 together with the base member 110, may rotatably support the shaft 120 and form a bearing clearance C1 filled with a lubricating fluid.

Meanwhile, the sleeve 130 may be inserted into and fixedly installed on the installation part 112 of the base member 110. That is, an outer peripheral surface of the sleeve 130 may be adhered to an inner peripheral surface of the installation part 112 by an adhesive.

Further, the sleeve 130 may include a shaft hole 132 formed therein, wherein the shaft hole 132 has the shaft 120 inserted thereinto. Further, in a case in which the shaft 120 is inserted into the shaft hole 132 of the sleeve 130, an inner peripheral surface of the sleeve 130 and the outer peripheral surface of the shaft 120 may be spaced apart from each other by a predetermined interval to thereby form a bearing clearance C1 therebetween.

Here, the bearing clearance C1 will be described in more detail. As described above, the sleeve 130 may form the bearing clearance C1 filled with the lubricating fluid. This bearing clearance C1 indicates a clearance formed by the shaft 120 and the sleeve 130, a clearance formed by an upper end portion of the sleeve 130 and the rotor hub 150, a clearance formed by the sleeve 130 and the stopper member 160, a clearance formed by the cover member 140 and the sleeve 130, and a clearance formed by the cover member 140 and the lower surface of the shaft 120.

In addition, the spindle motor 100 according to the present embodiment may have a structure in which the lubricating fluid fills the entire bearing clearance C1. This structure may be called a full-fill structure.

Meanwhile, the sleeve 130 may include upper and lower radial dynamic pressure grooves 133 and 134 formed in an inner peripheral surface thereof in order to generate fluid dynamic pressure at the time of the rotational driving of the shaft 120. In addition, the upper and lower radial dynamic pressure grooves 133 and 134 may be disposed to be spaced apart from each other by a predetermined interval and have a herringbone or spiral shape.

In addition, at the time of the rotational driving of the shaft 120, the lubricating fluid may move from the upper radial dynamic pressure groove 133 toward the lower radial dynamic pressure groove 134. That is, the spindle motor 100 according to the present embodiment may finally have a down pumping structure.

Meanwhile, the sleeve 130 may include a flange part 135 extended so as to be disposed over the stopper member 160. In addition, the flange part 135 may serve to prevent the rotor hub 150 from being separated from the shaft 120.

In addition, the sleeve 130 may include a circulation hole 136 formed therein in order to connect upper and lower portions thereof to each other, wherein the circulation hole 136 may be connected to a space formed by the stopper member 160 and an outer peripheral surface of the sleeve 130.

More specifically, the sleeve 130 may include a depression groove 137 formed under the flange part 135 and connected to the circulation hole 136.

In addition, the circulation hole 136 may be inclined so as to be connected to the depression groove 137. That is, the circulation hole 136 may be inclined so as to be connected to the above-mentioned depression groove 137 simultaneously with connecting the bearing clearance C1 formed by the sleeve 130 and the cover member 140 and the bearing clearance C1 formed by the sleeve 130 and the rotor hub 150 to each other.

Therefore, the circulation hole 136 may connect three bearing clearances C1 to each other.

Meanwhile, the sleeve 130 may include amounting groove 138 formed in a lower end portion thereof so that the cover member 140 may be installed thereon.

The cover member 140, that is, a fixed member configuring the stator 20 together with the base member 110 and the sleeve 130 described above, may be installed in the lower end portion of the sleeve to thereby serve to prevent the lubricating fluid filling the bearing clearance C1 from being leaked to the lower end portion of the sleeve 130.

Meanwhile, the cover member 140 may be bonded to the mounting groove 138 of the sleeve 130 by an adhesive and/or welding.

The rotor hub 150, that is, a rotating member configuring the rotor 40 together with the shaft 120, may be coupled to an upper end portion of the shaft 120 and include an extension wall part 152 downwardly in an axial direction to be disposed outwardly of the sleeve in a radial direction.

Meanwhile, the rotor hub 150 may include a rotor hub body 154 provided with an mounting hole 154a into which the upper end portion of the shaft 120 is inserted, a magnet mounting part 156 extended downwardly from an edge of the rotor hub body 154 in the axial direction, and a disk seat part 158 extended from a distal end of the magnet mounting part 156 in the outer diameter direction.

In addition, the magnet mounting part 156 may have a driving magnet 156a installed on an inner surface thereof, wherein the driving magnet 156a is disposed to face a front end of the stator core 104 having the coil 102 wound therearound.

Meanwhile, the driving magnet 156a may have an annular ring shape and be a permanent magnet generating magnetic force having a predetermined strength by alternately magnetizing an N pole and an S pole in a circumferential direction.

Here, rotational driving of the rotor hub 150 will be briefly described. When power is supplied to the coil 102 wound around the stator core 104, driving force capable of rotating the rotor hub 150 may be generated by electromagnetic interaction between the driving magnet 156a and the stator core 104 having the coil 102 wound therearound.

Therefore, the rotor hub 150 may rotate. In addition, the shaft 120 on which the rotor hub 150 is fixedly installed may rotate together with the rotor hub 150 by the rotation of the rotor hub 150.

In addition, the extension wall part 152 described above may be extended downwardly from a lower surface of the rotor hub body 154 in the axial direction and be stepped so that the stopper member 160 may be installed thereon.

The stopper member 160 may be fixedly installed on the extension wall member 152 of the rotor hub 150 and form, together with the outer peripheral surface of the sleeve 130, a space in which a liquid-vapor interface is formed.

In addition, an inner peripheral surface of the stopper member 160 and the outer peripheral surface of the sleeve 130 disposed to face the inner peripheral surface of the stopper member 160 may be inclined so that an interface between the lubricating fluid and air may be formed.

Further, in a case in which the stopper member 160 is installed on the extension wall part 152, the flange part 135 of the sleeve 130 may be disposed on the upper portion of the stopper member 160 so as to face the stopper member 160. Therefore, at the time of external impact, since the stopper member 160 is supported by the extension wall part 152, separation of the rotor hub 150 from the shaft 120 may be prevented.

In addition, a second thrust dynamic pressure groove 162 for generating fluid thrust dynamic pressure may be formed in at least one of an upper surface of the stopper member 160 and a lower surface of the flange part 135.

Therefore, at the time of the rotation of the shaft 120, the fluid thrust dynamic pressure may be generated, whereby the rotation of the rotor hub 150 may be more stably supported.

In addition, the lubricating fluid may move along the flange part 135 and the circulation hole 136 by the second thrust dynamic pressure groove 162.

Here, a movement path of the lubricating fluid will be described.

First, as shown in FIG. 6, at the time of the rotational driving of the shaft 120, a first lubricating fluid circulation S1 in which the lubricating fluid moves from a lower portion of the circulation hole 136 toward an upper portion thereof and a second lubricating fluid circulation S2 in which the lubricating fluid moves from the circulation hole 136 toward the bearing clearance C1 formed by the flange part 135 and the stopper member 160 may be generated.

That is, a movement path of the first lubricating fluid circulation S1 is as follows.

First, the lubricating fluid may move from the upper radial dynamic pressure groove 133 to the lower radial dynamic pressure groove 134, and then, may move from the lower portion of the circulation hole 136 toward the upper portion thereof, and then may move in the inner diameter direction in the bearing clearance C1 formed by the rotor hub 150 and the upper surface of the sleeve 130.

In addition, a movement path of the second lubricating fluid circulation S2 is as follows. The lubricating fluid may move from the second thrust dynamic pressure groove 162 to the bearing clearance C1 formed by the flange part 135 and the extension wall part 152 by the second thrust dynamic pressure groove 162, and then, may move in the inner diameter direction in the bearing clearance C1 formed by the rotor hub 150 and the upper surface of the sleeve 130, and then may move from the upper portion of the circulation hole 136 to the depression groove 137.

As described above, since the second lubricating fluid circulation S2 is generated, negative pressure generation and abnormal increase in pressure may be suppressed. That is, the second lubricating fluid circulation S2 is generated in an area in which there is a possibility that pressure will become unstable, whereby the generation of the negative pressure and the abnormal increase in pressure may be relatively reduced.

In addition, air bubbles generated at the time of the rotational driving of the shaft 120 may be relatively more easily discharged to the outside by the second lubricating fluid circulation S2. That is, the air bubble moving from the lower portion of the circulation hole 136 to the upper portion thereof may move to a space in which the liquid-vapor interface is formed through the depression groove 137 by the second lubricating fluid circulation S2.

Therefore, the air bubbles may be relatively easily discharged.

As described above, the stopper member 160 may be installed on the extension wall part 152, such that a bearing span length is increased, whereby rotational characteristics may be improved and power consumption may be reduced.

Here, the bearing span length indicates a distance between a region in which maximum dynamic pressure is generated while the lubricating fluid is pumped by the upper radial dynamic pressure groove 133 and a region in which maximum dynamic pressure is generated when the lubricating fluid is pumped by the lower radial dynamic pressure groove 134.

That is, the stopper member 160 is installed on the extension wall part 152, such that a spaced distance between the upper and lower radial dynamic pressure grooves 133 and 134 is increased, whereby the bearing span length may be increased.

Therefore, the rotational characteristics may be improved and the power consumption may be reduced.

In addition, since force pulling the rotor hub 150 toward the base member 110 by magnetic force is not required through the first and second thrust dynamic pressure grooves 122 and 162, in other words, a double thrust structure, the pulling plate needs not to be installed, whereby a manufacturing cost may be reduced.

Further, since the force pulling the rotor hub 150 toward the base member 110, that is, pulling force is not required, loss of power for generating the puling force may be reduced, whereby the power consumption may be reduced.

In addition, since the upper and lower portions of the sleeve 130 and the outer peripheral surface of the sleeve 130 maybe connected to each other through the circulation hole 136, the generation of the negative pressure and the abnormal increase in pressure may be prevented.

Further, the air bubbles may be easily discharged through the circulation hole 136 as described above.

Hereinafter, a spindle motor according to another embodiment of the present invention will be described with reference to the accompanying drawings. However, a detailed description of the same components as the above-mentioned components will be omitted and be replaced by the above-mentioned description.

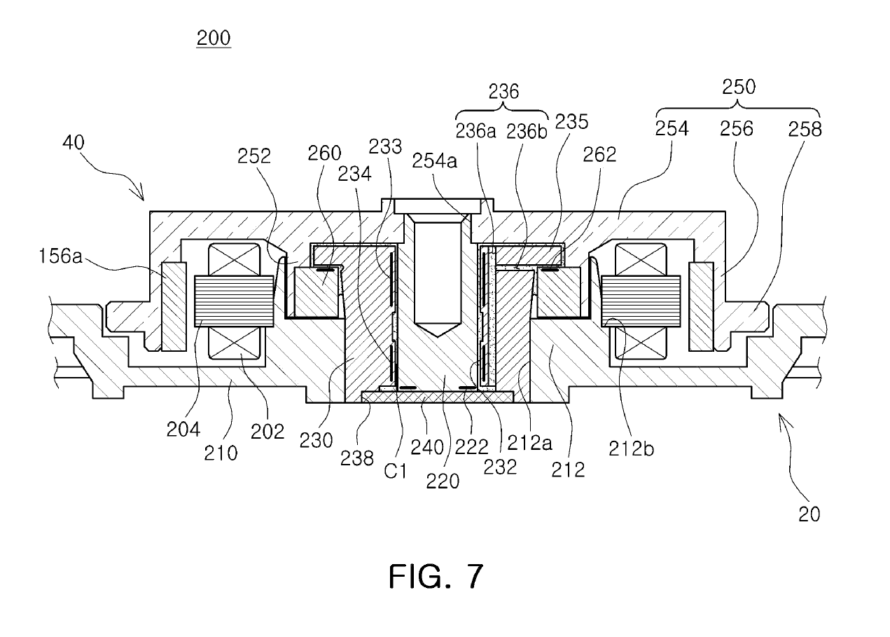

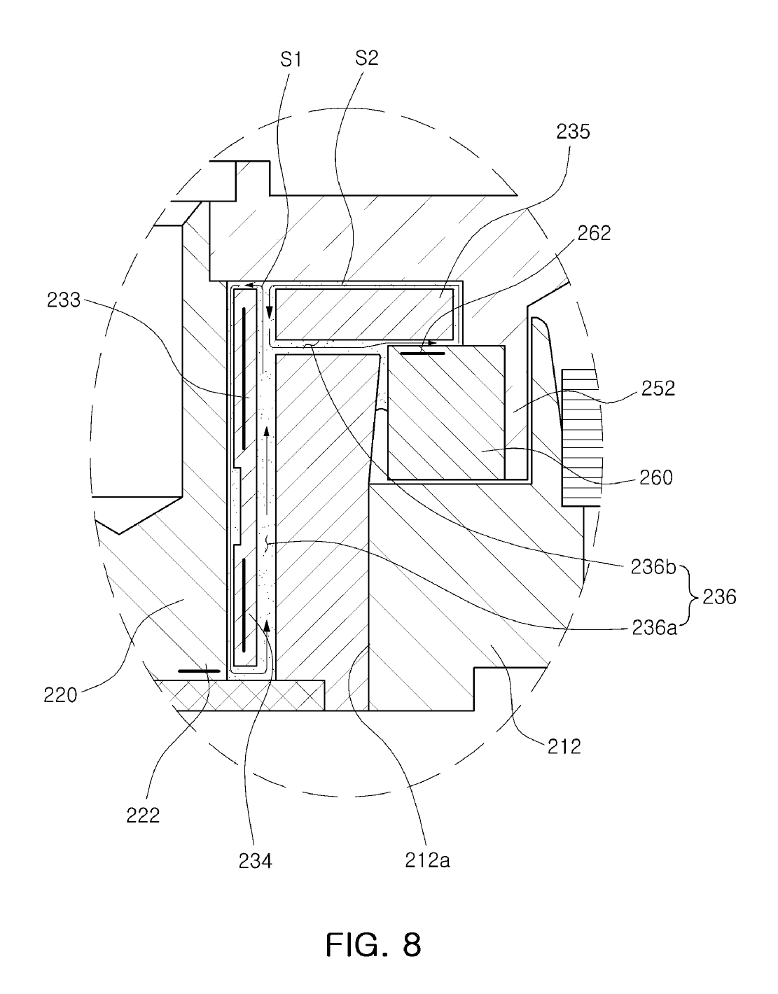

FIG. 7 is a schematic cross-sectional view showing a spindle motor according to another embodiment of the present invention; and FIG. 8 is a view describing an operation of the spindle motor according another embodiment of the present invention.

Referring to FIGS. 7 and 8, a spindle motor 200 according to another embodiment of the present invention may include a base member 210, a shaft 220, a sleeve 230, a cover member 240, a rotor hub 250, and a stopper member 260 by way of example.

Meanwhile, the base member 210, the shaft 220, the cover member 240, the rotor hub 250, and the stopper member 260 included in the spindle motor 200 according to another embodiment of the present invention are substantially the same components as the base member 110, the shaft 120, the cover member 140, the rotor hub 150, and the stopper member 160 included in the spindle motor 100 according to the embodiment of the present invention described above. Therefore, a detailed description thereof will be omitted and be replaced by the above-mentioned description.

The sleeve 230 may form a bearing clearance C1 filled with a lubricating fluid.

Meanwhile, the sleeve 230 may be inserted into and be fixedly installed on an installation part 212 of the base member 210. That is, an outer peripheral surface of the sleeve 230 may be adhered to an inner peripheral surface of the installation part 212 by an adhesive.

Further, the sleeve 230 may include a shaft hole 232 formed therein, wherein the shaft hole 232 has the shaft 220 inserted thereinto. Further, in a case in which the shaft 220 is inserted into the shaft hole 232 of the sleeve 230, an inner peripheral surface of the sleeve 230 and the outer peripheral surface of the shaft 220 may be spaced apart from each other by a predetermined interval to thereby form the bearing clearance C1 therebetween.

Here, the bearing clearance C1 will be described in more detail. As described above, the sleeve 230 may form the bearing clearance C1 filled with the lubricating fluid. This bearing clearance C1 may indicate a clearance formed by the shaft 220 and the sleeve 230, a clearance formed by an upper end portion of the sleeve 230 and the rotor hub 250, a clearance formed by the sleeve 230 and the stopper member 260, a clearance formed by the cover member 240 and the sleeve 230, and a clearance formed by the cover member 240 and the lower surface of the shaft 220.

In addition, the spindle motor 200 according to the present embodiment may have a structure in which the lubricating fluid fills the entire bearing clearance C1. This structure may be called a full-fill structure.

Meanwhile, the sleeve 230 may include upper and lower radial dynamic pressure grooves 233 and 234 formed in an inner peripheral surface thereof in order to generate fluid dynamic pressure at the time of the rotational driving of the shaft 220. In addition, the upper and lower radial dynamic pressure grooves 233 and 234 may be formed to be spaced apart from each other by a predetermined interval and have a herringbone or spiral shape.

In addition, at the time of the rotational driving of the shaft 220, the lubricating fluid may move from the upper radial dynamic pressure groove 233 toward the lower radial dynamic pressure groove 234. That is, the spindle motor 200 according to the present embodiment may finally have a down pumping structure.

Meanwhile, the sleeve 230 may include a flange part 235 extended so as to be disposed over the stopper member 260. In addition, the flange part 235 may serve to prevent the rotor hub 250 from being separated from the shaft 220.

In addition, the sleeve 230 may include a circulation hole 236 formed therein in order to connect upper and lower portions thereof to each other, wherein the circulation hole 236 may be connected to a space formed by the stopper member 260 and an outer peripheral surface of the sleeve 230.

In addition, the circulation hole 236 may include a first lubricating fluid circulation hole 236a for connecting upper and lower portions of the sleeve 230 to each other and a second lubricating fluid circulation hole 236b having one end connected to the first lubricating fluid circulation hole 236a and the other end connected to the space formed by the stopper member 260 and the outer peripheral surface of the sleeve 230.

That is, the first lubricating fluid circulation hole 236a may be formed in the axial direction, and the second lubricating fluid circulation hole 236b may be formed in the radial direction so as to connect the first lubricating fluid circulation hole 236a to the space formed by the stopper member 260 and the outer peripheral surface of the sleeve 230.

Therefore, the circulation hole 236 may connect three bearing clearances C1 to each other.

Meanwhile, the sleeve 230 may include a mounting groove 238 formed in a lower end portion thereof so that the cover member 240 may be installed thereon.

Here, a movement path of the lubricating fluid will be described.

First, at the time of the rotational driving of the shaft 220, a first lubricating fluid circulation S1 in which the lubricating fluid moves from a lower portion of the first lubricating fluid circulation hole 236a toward an upper portion thereof and a second lubricating fluid circulation S2 in which the lubricating fluid moves from the second lubricating fluid circulation hole 236b toward the bearing clearance C1 formed by the flange part 235 and the stopper member 260 may be generated.

That is, a movement path of the first lubricating fluid circulation S1 is as follows.

First, the lubricating fluid may move from the upper radial dynamic pressure groove 233 to the lower radial dynamic pressure groove 234, and then, may move from the lower portion of the first lubricating fluid circulation hole 236a toward the upper portion thereof, and then, may move in the inner diameter direction in the bearing clearance C1 formed by the rotor hub 250 and the upper surface of the sleeve 230.

In addition, a movement path of the second lubricating fluid circulation S2 is as follows. The lubricating fluid may move from the second thrust dynamic pressure groove 262 to the bearing clearance C1 formed by the flange part 235 and the extension wall part 252 by the second thrust dynamic pressure groove 262, and then, may move in the inner diameter direction in the bearing clearance C1 formed by the rotor hub 250 and the upper surface of the sleeve 230, and then, may move from the upper portion of the first lubricating fluid circulation hole 236a to the second lubricating fluid circulation hole 236b.

As described above, since the second lubricating fluid circulation S2 is generated, negative pressure generation may be suppressed. That is, the second lubricating fluid circulation S2 maybe generated in a region in which the negative pressure is generated, whereby the generation of the negative pressure may be relatively reduced.

In addition, air bubbles generated at the time of the rotational driving of the shaft 220 may be relatively more easily discharged to the outside by the second lubricating fluid circulation S2. That is, air bubbles moving from the lower portion of the first lubricating fluid circulation hole 236a to the upper portion thereof may move to a space in which a liquid-vapor interface is formed through the second lubricating fluid circulation hole 236b.

Therefore, the air bubbles may be relatively easily discharged.

As described above, the stopper member 260 may be installed on the extension wall part 252, such that a bearing span length is increased, whereby rotational characteristics may be improved and power consumption may be relatively reduced.

Here, the bearing span length indicates a distance between a region in which maximum dynamic pressure is generated while the lubricating fluid is pumped by the upper radial dynamic pressure groove 233 and a region in which maximum dynamic pressure is generated when the lubricating fluid is pumped by the lower radial dynamic pressure groove 234.

That is, the stopper member 260 is installed on the extension wall part 252, such that a spaced distance between the upper and lower radial dynamic pressure grooves 233 and 234 is increased, whereby the bearing span length may be increased.

Therefore, the rotational characteristics may be improved and the power consumption may be reduced.

In addition, since force pulling the rotor hub 250 toward the base member 210 by magnetic force is not required through the first and second thrust dynamic pressure grooves 222 and 262, in other words, a double thrust structure, the pulling plate needs not to be installed, whereby a manufacturing cost may be reduced.

Further, since the force pulling the rotor hub 250 toward the base member 210, that is, pulling force is not required, loss of power for generating the puling force may be reduced, whereby the power consumption may be reduced.

In addition, since the upper and lower portions of the sleeve 230 and the outer peripheral surface of the sleeve 230 may be connected to each other through the circulation hole 236, the generation of the negative pressure and the abnormal increase in pressure may be prevented.

Further, the air bubbles may be relatively easily discharged through the circulation hole 236 as described above.

As set forth above, according to the embodiments of the present invention, the generation of a negative pressure and the excessive floating of the rotor may be reduced through the circulation hole formed to connect the upper and lower portions of the sleeve to each other and the space formed by the stopper member and the outer peripheral surface of the sleeve.

That is, since the circulation hole is connected to the space formed by the stopper member and the outer peripheral surface of the sleeve, pressure of the upper and lower portions of the sleeve connected to each other by the circulation hole may be controlled by atmospheric pressure. Therefore, the generation of the negative pressure may be relatively reduced, and the excessive floating of the rotor due to an abnormal increase in pressure may be prevented.

In addition, the air bubbles generated during the rotational driving of the shaft may be relatively easily discharged by a second circulation.

Further, the stopper member may not be installed on the shaft, such that the bearing span length may be increased, whereby the rotational characteristics may be improved and the power consumption may be relatively reduced.

Furthermore, the power consumption may be further reduced through the first and second thrust dynamic pressure bearings.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft;
a sleeve rotatably supporting the shaft and forming a bearing clearance therewith filled with a lubricating fluid;
a cover member installed on a lower end portion of the sleeve;
a rotor hub coupled to an upper end portion of the shaft and having an extension wall part extended downwardly in an axial direction to be disposed outwardly of the sleeve in a radial direction; and
a stopper member fixedly installed on the extension wall part of the rotor hub, and forming, together with an outer peripheral surface of the sleeve, a space having a liquid-vapor interface formed therein,
the sleeve including a circulation hole formed therein in order to connect upper and lower portions thereof to each other, the circulation hole being connected to a space formed by the stopper member and the outer peripheral surface of the sleeve.

2. The spindle motor of claim 1, wherein the circulation hole is inclined.

3. The spindle motor of claim 1, wherein the sleeve includes a flange part extended so as to be disposed over the stopper member.

4. The spindle motor of claim 1, wherein the sleeve includes a depression groove formed under the flange part and connected to the circulation hole.

5. The spindle motor of claim 3, wherein at least one of a lower surface of the shaft and an upper surface of the cover member is provided with a first thrust dynamic pressure groove for generating fluid thrust dynamic pressure.

6. The spindle motor of claim 3, wherein at least one of a lower surface of the flange part and an upper surface of the stopper member is provided with a second thrust dynamic pressure groove for generating fluid thrust dynamic pressure.

7. The spindle motor of claim 6, wherein a first lubricating fluid circulation in which the lubricating fluid moves from a lower portion of the circulation hole toward an upper portion thereof and a second lubricating fluid circulation in which the lubricating fluid moves from the circulation hole toward a bearing clearance formed by the flange part and the stopper member are generated at the time of rotational driving of the shaft.

8. The spindle motor of claim 1, wherein the sleeve includes upper and lower radial dynamic pressure grooves formed in an inner peripheral surface thereof in order to generate fluid dynamic pressure at the time of the rotational driving of the shaft, and
the lubricating fluid moves from the upper radial dynamic pressure groove toward the lower radial dynamic pressure groove.

9. The spindle motor of claim 1, wherein the circulation hole includes a first lubricating fluid circulation hole for connecting upper and lower portions of the sleeve to each other and a second lubricating fluid circulation hole having one end connected to the first lubricating fluid circulation hole and the other end connected to a space formed by the stopper member and the outer peripheral surface of the sleeve.

10. The spindle motor of claim 9, wherein a first lubricating fluid circulation in which the lubricating fluid moves from a lower portion of the first lubricating fluid circulation hole toward an upper portion thereof and a second lubricating fluid circulation in which the lubricating fluid moves from the second lubricating fluid circulation hole toward the bearing clearance formed by the flange part and the stopper member are generated at the time of the rotational driving of the shaft.
